(19) United States
(12) Patent Application Publication
(10) Pub. No.: US 2026/0264865 A1
(43) Pub. Date: Sep. 10, 2026

(54) HYBRID PROPULSION SYSTEM FOR VTOL AIRCRAFT

(71) Applicant: Alberto Carlos PEREIRA FILHO, São José dos Campos (BR)

(72) Inventor: Alberto Carlos PEREIRA FILHO, São José dos Campos (BR)

(21) Appl. No.: 19/404,780

(22) Filed: Dec. 1, 2025

Related U.S. Application Data
(63) Continuation of application No. PCT/BR2023/050172, filed on May 31, 2023.

(51) Int. Cl. B64D 27/33; B64C 29/00; B64D 25/00; B64D 27/16; B64D 27/357; B64D 31/10; B64D 31/18

(52) U.S. Cl. CPC B64D 27/33; B64C 29/0033; B64D 25/00; B64D 27/16; B64D 27/357; B64D 31/10; B64D 31/18

(57) ABSTRACT

This document describes a HYBRID PROPULSION SYSTEM FOR VTOL AIRCRAFT, capable of meeting both VTOL mode, with vertical takeoff and landing, composed of 8 (eight) thrusters, with 4 (four) of them electric (1), preferably EDF type, and 4 (four) combustion thrusters (2), preferably turbofan type, and also enabling safe transition from vertical takeoff mode to horizontal flight, developing high speed and long range, with hybrid propulsion as its main characteristic, equipped with electric motors, preferably EDF (1) on the fuselage (3) and turbofan thrusters (2) on the wing tips (5) allowing safer landings and takeoffs.

High-speed aircraft manufacturers have long favored fixed-wing aircraft over the years, powered by turbojet or turbofan engines—single-engine or twin-engine, sometimes even four engines—but these require a runway to take off. Vertical takeoff and landing vehicles are known as vertical takeoff and landing (VTOL) machines, which do not require a runway for landing and takeoff, but demand relatively higher power, resulting in high fuel consumption, low speed, and limited flight range.

It is known that the major disadvantage of VTOL vehicles is that to fly horizontally without wings, they need considerable power to stay airborne, thus reducing the range of this type of aircraft. Fixed-wing aircraft perform this role well, minimizing fuel consumption to maintain cruise flight, but they cannot take off or land vertically because they lack sufficient thrust for this type of task.

Combining VTOL modes with high-speed horizontal flight, like that of fixed-wing aircraft, remains an unsolved challenge without compromising fuel consumption. This is because VTOL mode requires considerable thrust from the propellers.

Currently, engineers are working on ideas that blend the characteristics of different types of aircraft, with the goal of enabling vertical takeoff and landing while maintaining the performance and range of a conventional fixed-wing aircraft.

In this regard, the present patent document proposes a solution and presents a hybrid propulsion model—that is, the combination of two types of propellers—in order to overcome all these obstacles during flight modes.

### STATE OF THE ART

VTOL aircraft with transition to horizontal flight are known from the state of the art, such as the one we can see in patent No. U.S. Pat. No. 8,636,24, United States, which shows a hybrid jet/electric VTOL aircraft containing a fixed wing and a set of electric lift fans distributed on the aircraft fuselage and a generator coupled to the aircraft turbine engine. The present invention not only lacks a power transition system for the engines, but also lacks a motor system containing turbofans and EDF motors, a more recent technology suited to today's VTOL aircraft.

The U.S. Pat. No. 5,131,605A reveals a VTOL aircraft with four engines, a first engine nacelle mounted under the wing on one side of the fuselage and houses two of the aircraft's engines. The first engine nacelle is mounted in close proximity to the fuselage. A second engine nacelle is mounted under the wing on the opposite side of the fuselage from the first nacelle and houses the two remaining engines. The present invention shown in this patent is more complex and does not present a transition system between VTOL takeoff mode and horizontal flight mode.

The European patent document No. EP3932805A1 filed at the European Patent Office presents a “hybrid propulsion system for convertible aircraft,” containing a hybrid propulsion system for a tiltrotor aircraft that comprises one or more engines that provide thrust whenever the tiltrotor aircraft is in a first forward flight mode, one or more sources of electrical or hydraulic power, and two or more sets of pylons. This patent, in addition, does not present a safety or flight system.

The patent document EP38787361

filed at the European Patent Office presents a system of “Aircraft with convertible rear boom and landing gear systems”, containing a convertible tiltwing (10) between a vertical takeoff and landing flight mode and a forward flight mode that includes a fuselage (12), a tilted wing (14, 16) rotatably coupled to the fuselage, and a convertible rear boom and landing gear system (38) rotatably coupled to the fuselage.

Despite all the patents presented and others that developed other VTOL technologies, we found nothing in the state of the art that anticipates the characteristics and claims presented in the patent application claimed here.

### SHORTCOMINGS OF THE STATE OF THE ART

It is known that one of the main limitations of the vertical takeoff and landing (VTOL) vehicle lies in its performance during horizontal flight, since, lacking wings, the vehicle exhibits characteristics of high fuel consumption and reduced speed.

In turn, hybrid propulsion VTOL vehicles face great difficulties in transitioning from vertical takeoff and landing mode to horizontal flight mode, when they then require great thrust from the engines for this maneuver. Once in cruise flight, this excess thrust needed for VTOL and transition compromises cruise flight due to excess engine power, especially in the case of thermal engines, because they are forced to operate at idle, and in the case of electric engines, it compromises payload due to the high weight of batteries.

Finally, the safety system in these VTOL-type vehicles has always been the weak point, especially during takeoff or landing mode. Any failure at this moment in one of the propellers can lead to catastrophic damage due to force instability involved, if one does not consider the set of propellers and their arrangement in the vehicle for better stability in case of engine failure.

The current system of vertical takeoff aircraft, better known as VTOL aircraft, especially the one described in the patent document filed with the PCT under No. PCTBR2020050388 by the same inventor, in which the aircraft performs vertical takeoff and then modulates to level flight, that is, horizontal flight.

As already described, the takeoff of a VTOL aircraft is the critical point. Whether in fuel consumption, in the balance of this transition, even in compromising the vehicle's payload, and especially in the safety factor, should any of the engines fail.

In this regard, to improve this takeoff performance and consequently the aircraft's flight, the inventor, a renowned engineer in the segment, who comes with the said patent document, provides a better solution in this VTOL and high-speed, long-range cruise flight marriage, with safety and vehicle balance.

Therefore, the present patent document addresses a technological innovation for vertical takeoff aircraft called “Hybrid Propulsion System for VTOL Aircraft,” whose propulsion is of the hybrid type and integrated with a dual command system for greater safety—that is, from this system one can establish conditions for VTOL, transition, and high-speed cruise flight with safety and stability in all flight modes.

The present configuration of the invention is composed of eight engines: 4 EDF motors (ducted fan) embedded inside the aircraft fuselage for control during landing and takeoff assistance. The EDF motor is composed of an electric motor coupled to a set of fan blades, which is mounted inside a narrow duct. When the electric motor is turned on, the fan blades spin rapidly and push air through the duct, creating a high-speed airflow that generates thrust.

The EDF propellers are powered by an electric battery and controlled by an electronic system that adjusts the motor speed to control the thrust generated, thus controlling flight during VTOL and transition. In addition to the EDF motors, the assembly consists of 4 (four) additional propellers at the wing tips for long-range, high-speed cruise flight.

The EDF motors are the basis of aircraft control during takeoff or landing in VTOL mode. More precise and with quick responses, they are fixed inside the fuselage at strategic points in relation to the aircraft's center of gravity. With independent rotation control where it is possible to control their thrust, they provide greater precision, safety, and stability in landings and takeoffs.

Four turbofans are located at the wing tip and can change their force collectively or individually to alter the direction and speed of horizontal flight, in addition to assisting the EDFs during takeoff and vertical landing, helping in VTOL mode.

The present document concerns a HYBRID PROPULSION SYSTEM FOR VTOL AIRCRAFT, capable of meeting both VTOL mode and cruise flight, and furthermore, without penalizing the high-speed and long-range flight of the aircraft. Its main characteristic is hybrid propulsion, equipped with electric and combustion engines.

The claimed invention relates to hybrid propulsion with innovative characteristics in conception and especially in the turbofan propeller model that allows operation over a wide range of thrust and has a high thrust-to-weight ratio of the motor that significantly influences its VTOL application and cruise flight.

Under this condition of hybrid propulsion and with 8 propellers, the aircraft has greater cruise speed, range, and safety, requiring no runway for takeoff.

Safety is another fundamental factor, and the use of 8 motors working independently and composed of a hybrid system controlled independently and dual navigation and control system allow safe and stable flight modes in any situation.

All of this gives the aircraft versatile behavior with vertical landings and takeoffs and flying normally horizontally like a high-speed fixed-wing aircraft, powered by turbofan engines.

### TRANSITION MOVEMENT

One of the most notable characteristics of this invention is the ability of turbofan engines to perform the movement known as “tilt”. The “tilt” refers to the articulation mechanism of the engines, allowing them to tilt or rotate in relation to the aircraft wing. This movement is possible thanks to the design of the turbofan with light engine weight compared to its thrust and a rotation system called “articulation” or “engine articulation,” which allows adjusting the angle of direction of the thrust generated by the engines.

In the present takeoff system, with the turbofan axis positioned perpendicular to the aircraft's axial axis, the EDF engines start operating, and at the same time the turbofans as auxiliary engines are activated and maintained at a given power. With acceleration and control of the EDFs, the takeoff begins. After reaching the ideal altitude, which depends on the mission type, the axis begins to transition to horizontal flight, with stability provided by the EDF engines and vehicle acceleration occurring through increased turbofan thrust and rotation to a position parallel to the vehicle's axis. After twenty percent of stall speed, the electric motors are shut down and cruise flight begins with turbofan propulsion, in a manner similar to conventional fixed-wing aircraft.

It is worth noting that during takeoff, landing, glide flight, and transition, all aircraft control is performed by the EDF engines, which are more precise, and the turbofans only provide auxiliary thrust, contributing in part to the power needed to keep the vehicle airborne. In other words, all control in VTOL modes and transition is performed by the EDFs.

In transition mode, the turbofan engines begin a controlled rotation sequence, while the EDF engines continue controlling and stabilizing the vehicle until the vehicle reaches a speed slightly above stall speed. When the vehicle reaches level and sustainable flight mode, the EDF engines are deactivated and concealed inside the fuselage.

At this point, the control system transfers all control to the Turbofan engines, which operate in cruise mode at high speed, as in a conventional airplane.

In case of emergency, the aircraft's dual propulsion system provides greater safety in any flight mode. If there is a failure in the EDF engine system, the Turbofans maintain flight balance, and similarly, if the failure is in the Turbofans, the EDF engines sustain the aircraft.

Considering the above, we have a HYBRID PROPULSION SYSTEM FOR VTOL AIRCRAFT, an unprecedented configuration that provides greater safety and flight efficiency, because after reaching a certain flight speed, the turbofans, now aligned with the aircraft's axis, become its main propellers that pull it forward.

Electric propellers are limited in terms of high speed and offer little flight range due to the low energy density of current batteries. However, when used only in VTOL mode and transition and with Turbofans as auxiliary thrust propellers, it gains advantages such as greater range for this task and lower battery weight.

Electric propellers have limitations regarding high speed, due to their limitation in the exhaust velocity of the EDFs, and range, due to the low energy density of current batteries. However, these limitations are mitigated when electric propellers are used only during takeoff and landing of the aircraft, being assisted by Turbofans. In these cases of landings and takeoffs, and transition, electric propellers, with more refined control, assisted by turbofans, gain greater range, even with the use of few batteries, making this system more suitable for this task.

The present propulsion model fits the criteria that define technological innovation, presenting these two advantages of flight dynamics: VTOL takeoff combined with high speed, with greater flight range.

On the other hand, jet propellers, such as turbofans, are known for high speed and great flight range, thanks to their high energy density and low fuel consumption. However, they are not suitable for VTOL mode, as their flight control response is slow. This occurs because changes in the thrust of these engines have a long response time, which makes it difficult to control the vehicle properly.

The innovative solution proposed here is a hybrid propulsion system, composed of four EDF propellers capable of providing precise control to the vehicle during VTOL and transition, that is, until the aircraft enters its level flight mode, combined with four turbofan-type propellers for aircraft propulsion in all flight modes, but mainly for high-speed cruise flight with great range.

### BRIEF DESCRIPTION OF THE LAYOUT DRAWINGS

To complement the present description in order to obtain a better understanding of the characteristics of the present invention and in accordance with its preferred embodiment, a set of drawings accompanies the description, where, in an exemplified manner, although not limiting, the following is represented:

FIG. 1—Shows the aircraft model configuration with EDF engines in the fuselage with turbofans in the horizontal position.

FIG. 2—Shows the aircraft with propellers in the vertical position for takeoff or landing.

FIG. 3—Shows the aircraft with propellers in the transition position.

FIG. 4—Shows details of the EDF engines in an X-ray view of the fuselage.

FIG. 5—Shows the schematic diagram of takeoff, transition, and horizontal flight.

### DETAILED DESCRIPTION OF THE INVENTION

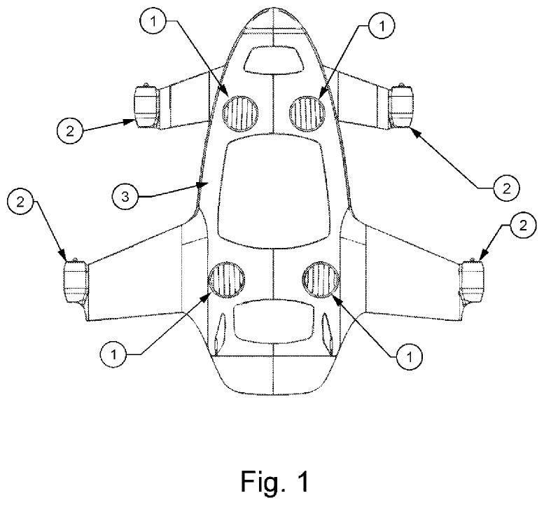

This document describes a hybrid propulsion system for takeoff and landing of VTOL aircraft. As presented in FIG. 1, it is composed of 8 (eight) propellers, 4 (four) of which are electric (1), preferably of the EDF type, and 4 (four) combustion propellers (2), preferably of the turbofan type, as can be seen in FIG. 1.

The present propulsion system was designed to provide takeoff, landing, and transition to high-speed horizontal flight in a safer manner with precise and redundant control during all these flight phases.

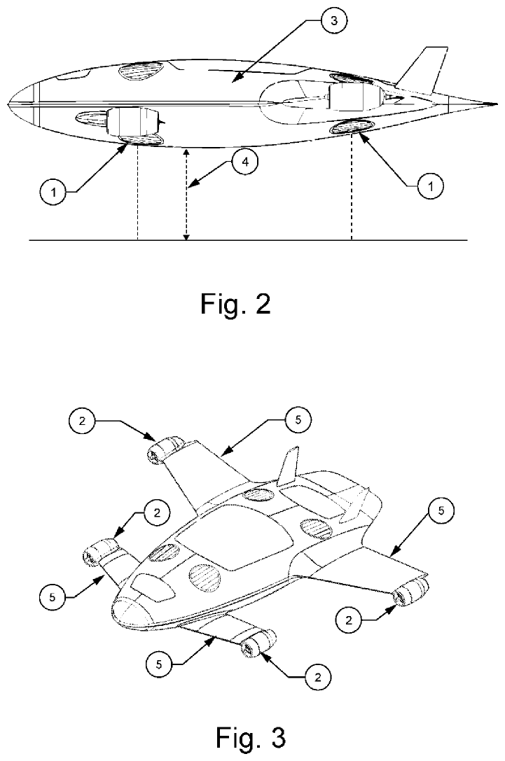

The respective “HYBRID PROPULSION SYSTEM FOR VTOL AIRCRAFT” allows takeoff and landing and respective transition to cruise mode, which can be at high speed, designed with four EDF-type engines (1) installed inside the fuselage (3) at strategic points in relation to the aircraft's center of gravity (CG) (4), plus four turbofan-type propellers (2) installed at the wing tips (5), as shown in FIGS. 2 and 3, operable to propel and rotate to move the vehicle, lift or lower it vertically, and perform horizontal cruise flight, and then return to vertical flight to land vertically.

EDF propellers, being powered by electric batteries and controlled by a high-precision electronic system that adjusts motor speed to control thrust during VTOL mode and its transition to horizontal flight.

The position of each engine inside the fuselage (3) of the VTOL aircraft is adjusted based on its center of gravity (4) so as to allow greater thrust stability and emergency landing safety in case of failure of any of the engines, whether EDF engines (1) or turbofan engines (2), as shown in FIG. 2.

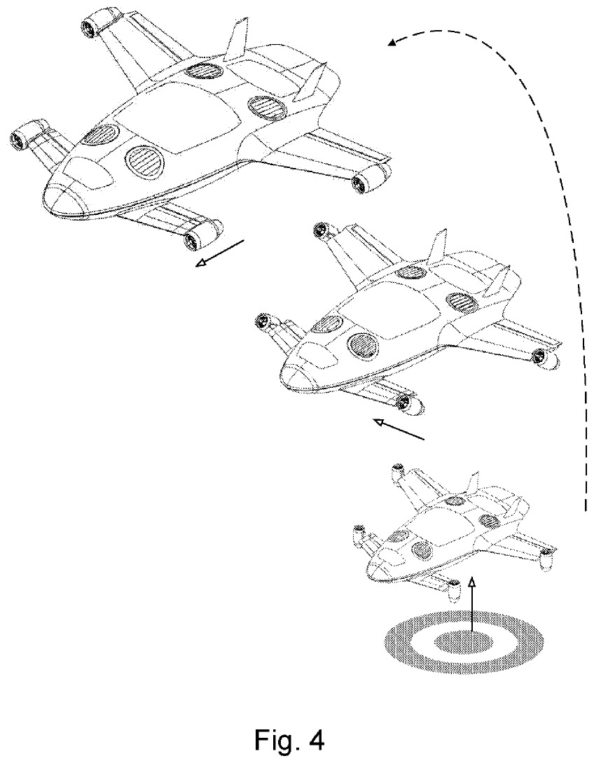

During takeoff of the VTOL aircraft, the turbofan propellers (2) are positioned perpendicular to the VTOL aircraft's axial axis, as illustrated in FIG. 4. When the aircraft begins its transition, the turbofan axis begins to rotate for transition to horizontal flight, maintaining vehicle stability with the help of electric propellers. These can develop joint or differential thrust, allowing precise control of rotation and translation during VTOL mode and transition.

During landings and takeoffs, the thrust generated by the set of 8 (eight) engines (1, 2) provides smooth and controlled flight in any mode, due to its Merit Factor (MF) which was sized to meet lift and control conditions as required. The MF is an essential requirement for VTOL-type vehicles; it is defined as the ratio between the aircraft's weight and the thrust required for its takeoff.

This ratio must meet an MF range between 0.4 and 0.7, so that the aircraft does not suffer from lack of thrust and stability failure during VTOL. In this configuration, the turbofan engines (2) support the EDF engines (1), meeting the MF and maintaining constant thrust at average power to support and balance the aircraft. The entire HYBRID PROPULSION SYSTEM FOR VTOL AIRCRAFT composed of 8 (eight) propellers assist in safety mode in case of EDF engine failure (1), or vice versa, providing excellent safety to VTOL vehicles.

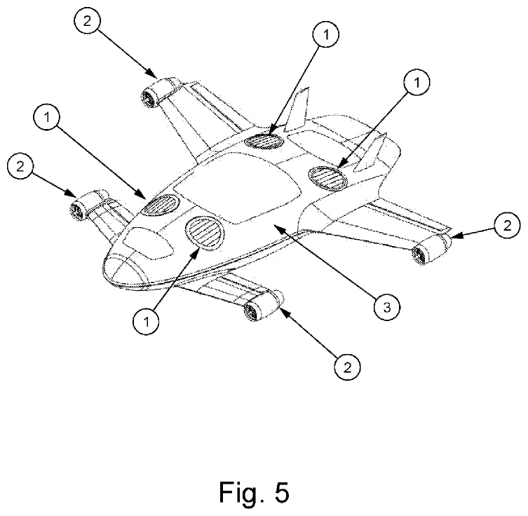

The present system, when in horizontal cruise flight, uses these turbofan engines (2) in horizontal position, as can be seen in FIG. 5. During cruise flight, the respective propellers are operated to develop thrust, providing smooth and efficient movement. The tilt of these engines also helps with vehicle stability during cruise flight.

In this cruise flight configuration, its four turbofan engines (2) developed especially to meet the requirements of this system, with the help of the wings, generate high speed without sacrificing aircraft efficiency.

On the other hand, the respective EDF propellers (1), embedded inside the fuselage (3) of the aircraft, when in cruise flights, are shut down. This way the battery energy used in takeoff can be recovered by the electric generator of the turbofans.

The Design of the Hybrid Propulsion System for VTOL Aircraft The navigation and control system, also known as the brain of the aircraft, is responsible for complete command of takeoff, landing, gliding, transition, and level flight, including safety systems.

The respective navigation and control system features three subsystems: two propulsion sets and a flight control system that controls all takeoff, landing, and cruise operations of the VTOL aircraft. The flight command and control system can be dual for greater safety and operates all engines simultaneously and independently

or not, providing high precision and stability.

The respective system is responsible for controlling all flight of the VTOL aircraft during landings, takeoffs, and ensuring vehicle stability.

The EDF thrusters (1) are powered by battery sources and have a driver to control their rotation speed in order to adjust the desired thrust with precision. The set, operating independently, allows precise control both in VTOL mode and during the transition to stabilized flight of the aircraft, when then, the 4 (four) turbofan engines take over (2).

It is certain that when the present invention is put into practice, modifications may be introduced regarding certain construction details and form, without departing from the fundamental principles that are clearly substantiated in the claims section, it being understood that the terminology used was for description purposes and not limitation.

1) HYBRID PROPULSION SYSTEM FOR VTOL AIRCRAFT, substantially composed of a hybrid propulsion system made up of a set of electric motors and combustion thrusters, wherein a set of electric motors (1), substantially EDF used for controlling takeoff, landing, and gliding flight, assisted by a set of combustion thrusters (2), substantially turbofans used to aid thrust during landing, takeoff, gliding flight, and transition, and for thrust in horizontal flight mode, developing high speeds.

2) HYBRID PROPULSION SYSTEM FOR VTOL AIRCRAFT, substantially composed of a hybrid propulsion system made up of a set of electric motors and combustion thrusters, according to claim 1, wherein the respective set of EDF-type thrusters, responsible for controlling aircraft flight in VTOL mode, whether during takeoff and landing or during gliding flights and transition mode, in any direction, always maintaining stability and control of vehicle direction and speed.

3) HYBRID PROPULSION SYSTEM FOR VTOL AIRCRAFT, substantially composed of a hybrid propulsion system made up of a set of electric motors and combustion thrusters, according to claim 1, wherein the set of combustion thrusters (2), preferably turbofans, to provide support to the electric thrusters in VTOL mode and transition mode conditions.

4) HYBRID PROPULSION SYSTEM FOR VTOL AIRCRAFT, substantially composed of a hybrid propulsion system made up of a set of electric motors and combustion thrusters, according to claim 1, wherein the set of thrusters (2), preferably turbofans that rotate (tilt) to align with the aircraft axis during transition to horizontal flight, with the EDF motors (1) shutting down when the VTOL aircraft reaches a speed above stall speed.

5) HYBRID PROPULSION SYSTEM FOR VTOL AIRCRAFT, substantially composed of a hybrid propulsion system made up of a set of electric motors and combustion thrusters, according to claim 1, wherein using the batteries of the EDF motors (1) only during VTOL and transition, which can be recharged during horizontal flight by generators installed in the turbofans.

6) HYBRID PROPULSION SYSTEM FOR VTOL AIRCRAFT, substantially composed of a hybrid propulsion system made up of a set of electric motors and combustion thrusters, according to claim 1, wherein having the EDF thrusters (1) positioned on the fuselage in relation to the aircraft's center of gravity and, after takeoff, during horizontal flight, these thrusters are shut down, being activated again only during landing or in emergencies.

7) HYBRID PROPULSION SYSTEM FOR VTOL AIRCRAFT, substantially composed of a hybrid propulsion system made up of a set of electric motors and combustion thrusters, according to claim 1, wherein having a safety mechanism that automatically activates the electric propulsion system in case of flight failure or combustion engine failure, so that both the set of electric thrusters and combustion thrusters work together and in harmony to stabilize the aircraft and bring it to a safe landing.
